(19) United States
(12) Patent Application Publication
(10) Pub. No.: US 2016/0013682 A1
(43) Pub. Date: Jan. 14, 2016

(54) SYSTEM AND METHOD FOR A LINEAR BASED CHARGER AND A WIRELESS CHARGER

(71) Applicant: RYTEC CORPORATION, Jackson, WI (US)

(72) Inventors: Shawn OSTENDORF, Milwaukee, WI (US); Jeffrey MALINOWSKI, Hartford, WI (US); Andrew SCHUMACHER, West Bend, WI (US)

(73) Assignee: RYTEC CORPORATION, Jackson, WI (US)

(21) Appl. No.: 14/789,686

(22) Filed: Jul. 1, 2015

Related U.S. Application Data
(60) Provisional application No. 62/021,867, filed on Jul. 8, 2014.
(60) Provisional application No. 62/185,878, filed on Jun. 29, 2015.

(51) Int. Cl. H02J 7/02; H02J 7/00

(52) U.S. Cl. CPC H02J 7/025; H02J 7/0052; H02J 7/0042; H02J 7/027

(57) ABSTRACT

A charging device for use with a door assembly is described. The charging device for use with a door assembly is configured to convert kinetic energy of linear motion to electromotive force and includes a rechargeable power source coupled to the charging device, wherein the linear motion is caused by movement of the door assembly to charge the rechargeable power source. Also, a charging device and method for wirelessly charging an electrical storage device on a door assembly includes a transmitting coil positioned proximate a door assembly and a receiving coil positioned on a door assembly for inductively charging the electrical storage device and for powering a senor for wirelessly sending an alert signal.

This application claims benefit and priority to U.S. Provisional Application No. 62/021,867 filed Jul. 8, 2014 and U.S. Provisional Application No. 62/185,878 filed Jun. 29, 2015, the disclosures of which are incorporated by reference herein in their entirety

### BACKGROUND

1.0 Field of the Invention

The present disclosure relates to a system and a method for a wireless charger and, more particularly, a system and a method for a linear motion based wireless charger and a wireless charger for charging a rechargeable battery using motion derived by motion of a door, or mutual inductance, among other features.

2.0 Related Art

Currently, door assemblies and/or window assemblies, such as, e.g., for a high performance door used in commercial applications or a garage door, are often constructed with sensors to detect, or cause, a state change of the door or window. For example, a panel-type door may have one or more sensors to detect when an obstruction has or is about to interfere or block travel of the door when opening or closing. Such sensor may be positioned in or on the door or window, or positioned proximate the door or window. Such a sensor might be, e.g., a light beam type sensor.

In many implementations, the power for the sensor may be provided by a battery type device. DC or AC connections from a source from beyond the door are problematic because the motion of the doors inhibits or precludes safe connections of the DC or AC to a moving door from beyond the door. However, the battery must be changed at regular intervals, otherwise operation of the sensor will fail. Replacing batteries is often a source of problems and/or may be a significant inconvenience to maintain. If a battery is not changed when it reaches a depleted state, the sensors cannot function and damage to the door or window assembly, or injury to people or property might ensue.

Therefore, a solution that reduces the frequency of battery replacement may be of value for use with door and window assemblies.

### SUMMARY OF THE DISCLOSURE

The present disclosure overcomes the shortcomings of the prior art by providing a solution that includes reducing the frequency of battery replacement used for powering in sensors in door and window assemblies, among other features.

In one aspect, a charging device for use with a door assembly is provided that includes a charging device configured to convert kinetic energy of linear motion to electromotive force and a rechargeable power source coupled to the charging device, wherein the linear motion is caused by movement of the door assembly to charge the rechargeable power source. The charging device may comprise a magnet and at least one solenoid, wherein one of the magnet and at least one solenoid is configured to move in relation to the other to convert kinetic energy of linear motion to electromotive force. The charging device may comprise a cantilever spring, a magnet connected to the cantilever spring, and at least one solenoid configured to permit the magnet to move therewithin to convert kinetic energy of linear motion to electromotive force. The charging device may further comprise a weight connected proximate one end of the cantilever spring to cause the magnet to move in relation to the at least one solenoid. The charging device may comprise a generator configured to be mounted to the door assembly and configured to be connected by a tensioning device to a support structure of the door assembly, wherein the generator is configured to be propelled by motion of the door assembly to convert kinetic energy of linear motion to electromotive force. The charging device may comprise a generator configured to be mounted to the door assembly and configured to be in contact with a stationary support structure, wherein the generator is configured to be propelled by motion of the door assembly by frictional contact with the stationary support structure to convert kinetic energy of linear motion to electromotive force. The rechargeable power source may comprise one of a battery and a super cap.

In one aspect, a method of recharging a power source using linear motion of a door assembly may include the steps of providing a charging device configured to convert kinetic energy of linear motion to electromotive force and coupling the charging device to a rechargeable power source, wherein the linear motion is created by movement of the door assembly to charge the rechargeable power source. In the providing step, the charging device may comprise a generator and may further comprise the steps of connecting the generator to the door assembly and positioning the generator against a support member that supports the door assembly so that the generator moves by frictional contact against the support member to convert kinetic energy of linear motion to electromotive force. In the providing step, the charging device may comprise a magnet and at least one solenoid, wherein one of the magnet and at least one solenoid is configured to move in relation to the other to convert kinetic energy of linear motion to electromotive force. In one aspect, in the providing step, the charging device may comprise a cantilever spring, a magnet connected to the cantilever spring, and at least one solenoid configured to permit the magnet to move therewithin to convert kinetic energy of linear motion to electromotive force. In one aspect, the charging device may further comprise a weight connected proximate one end of the cantilever spring to cause the magnet to move in relation to the at least one solenoid. In one aspect, in the providing step the charging device may comprise a generator configured to be mounted to the door assembly and configured to be connected by a tensioning device to a support structure of the door assembly, wherein the generator is configured to be propelled by motion of the door assembly to convert kinetic energy of linear motion to electromotive force. In one aspect, in the providing step the charging device may comprise a generator configured to be mounted to the door assembly and configured to be in contact with a stationary support structure, wherein the generator is configured to be propelled by motion of the door assembly by frictional contact with the stationary support structure to convert kinetic energy of linear motion to electromotive force. The method may further include the step of mounting the charging device in or on the door assembly. In one aspect, in the coupling step the rechargeable power source comprises one of: a battery and a super cap.

In one aspect, a method of wirelessly recharging a power source is provided that includes the steps of providing at least one transmitting coil proximate but not contacting a door assembly, providing a receiving coil on the door assembly configured to receive energy wirelessly from the at least one transmitting coil by inductance and charging at least one electrical storage device on the door assembly. The method may further comprise mounting a safety sensor transmitter on the door assembly, the safety sensor transmitter configured to wirelessly provide an alert signal powered by the at least one electrical storage device for stopping movement of the door assembly. The method may further comprise configuring a sensor on the door assembly to detect obstructions, the sensor coupled to the safety sensor transmitter. The receiving coil may receive energy by inductance from the at least one transmitting coil. The at least one transmitting coil may comprise two transmitting coils configured to be operably inductively coupled to the receiving coil when the door assembly is in a first state and/or a second state.

In one aspect, a system for of wirelessly recharging a power source is provided. The system may comprise at least one transmitting coil positionable proximate a door assembly and a receiving coil configured on the door assembly and coupled to an electrical storage device, the electrical storage device configured on the door assembly, wherein the at least one transmitting coil provides energy to the receiving coil when the door assembly is in at least one of: a first state and a second state. The system may further comprise a sensor configured on the door assembly to detect obstructions in the door pathway, the sensor powered by the electrical storage device. The system may further comprise a transmitter configured to receive a first signal from the sensor and configured to transmit a second signal. The at least one transmitting coil may be coupled to the receiving coil by induction, i.e., inductively coupled. The electrical storage device may comprise a super capacitor. The first state may corresponds to an open position of the door assembly and the second state may comprise a closed state of the door assembly.

Additional features, advantages, and embodiments of the invention may be set forth or apparent from consideration of the detailed description and drawings. Moreover, it is to be understood that the foregoing summary of the invention and the following detailed description and drawings are exemplary and intended to provide further explanation without limiting the scope of the invention as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 is an example of a door assembly 100, configured according to principles of the disclosure;

FIG. 2 shows exemplary components of a detection assembly, according to principles of the disclosure;

FIG. 3 is an example of a charger device, configured according to principles of the disclosure;

FIG. 4 is an example of a charger device, configured according to principles of the disclosure;

FIG. 5 is an example of a charger device, configured according to principles of the disclosure; and

FIG. 6 is an example of a charger device, configured according to principles of the disclosure.

FIG. 7 is an example of a self-sustaining wireless system, configured according to principles of the disclosure.

FIG. 8 is a block diagram of components for wireless charging, configured according to principles of the disclosure.

The present disclosure is further described in the detailed description that follows.

### DETAILED DESCRIPTION OF THE DISCLOSURE

The disclosure and the various features and advantageous details thereof are explained more fully with reference to the non-limiting examples that are described and/or illustrated in the accompanying drawings and detailed in the following description and attachment. It should be noted that the features illustrated in the drawings are not necessarily drawn to scale, and features of one example may be employed with other examples as the skilled artisan would recognize, even if not explicitly stated herein. Descriptions of well-known components and processing techniques may be omitted so as to not unnecessarily obscure the examples of the disclosure. The examples used herein are intended merely to facilitate an understanding of ways in which the invention may be practiced and to further enable those of skill in the art to practice the examples of the disclosure. Accordingly, the examples herein should not be construed as limiting the scope of the invention.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise. The term “about” means within plus or minus 10%, unless context indicates otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

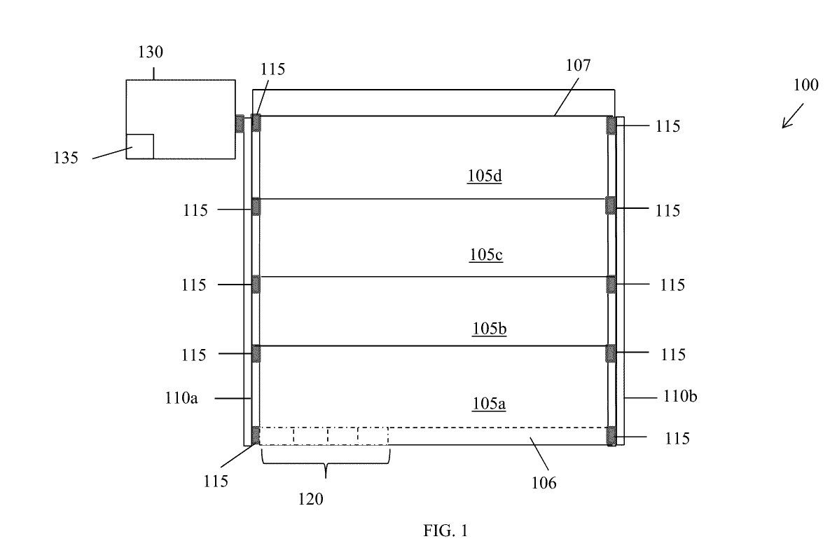

FIG. 1 is an example of a door assembly 100, configured according to principles of the disclosure. The door assembly may comprise one or more sections 105a-105d which may be panel-type sections or door panels, and may be installed in a wall of a building. In some applications, the one or more sections 105a-105d may be just one panel, e.g., as in the case of a single flexible type roll-up door. One or more support structures comprising a plurality of tracks 105a, 105b are shown spaced-apart and oriented in a vertical manner to support the one or more sections 105a-105d at each end while also permitting the one or more sections 105a-105d to travel upwards and downwards when opening and closing. The one or more sections 105a-105b may be connected to the plurality of tracks 105a, 105b by retaining mechanisms 115, which may be a roller or sliding type of mechanism that is configured to move along the plurality of tracks 105a, 105b. A powered controller 130 may control the motion of the door assembly 100 by causing the door assembly to open, close, start motion or stop motion upon receipt of an electrical signal. The powered controller 130 may include a wireless receiver 135 configured to receive a signal that indicates a state of the door assembly 100. The signal may indicate, e.g., that an obstacle was detected that may prevent safe motion of the one or more sections 105a-105d, or the signal might indicate that one or more sections 105a-105d was pulled from one of the tracks 105a, 105b.

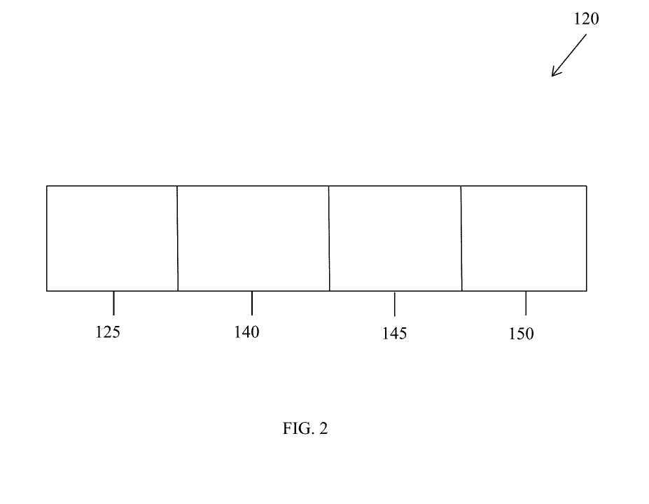

As shown in the example of FIG. 2, a detection assembly 120 may be configured to comprise a plurality of components including a detector 125, a wireless transmitter 140, a charger device 145 and a rechargeable power source 150 which may be, e.g., a battery or a super capacitor. The detection assembly 120 may be located, in part or in its entirety, in or on a lower portion 106 of section 105a, but may be located in part or in its entirety at other locations such as in or on other sections 105b-105d.

The components of the detection assembly 120 may be configured to be electrically connected, but do not necessarily need to be co-located. However, it may be beneficial in many applications that they are co-located, e.g., for assembly or access reasons. The detector 125 may be configured to detect an interruption of motion of the one or more sections 105a, 105d, and/or may be configured to detect that the section 105a (or other sections 105b-105d) has been separated from one of the tracks 110a, 110b. Separation might occur because of, e.g., an event such as a vehicle running into the door assembly 100. Any separation of any of the sections 105a-105d from a track 110a, 110b preferably leads to motion of the door assembly being stopped to avoid additional or subsequent damage. Stopping of motion may be accomplished by a wireless transmitter 140 sending a signal to a wireless receiver 135, which may result in the powered controller 130 stopping motion/movement of the door assembly 100.

The detection assembly 120 may further comprise a charger 145 to charge the rechargeable power source 150. The rechargeable power source 150 may comprise a rechargeable battery, e.g., a lead acid battery, a nickel cadmium battery, a nickel metal hydride battery, a lithium ion battery, a lithium ion polymer battery, or the like. The rechargeable power source 150 may comprise a non-battery power source such as, e.g., a super capacitor.

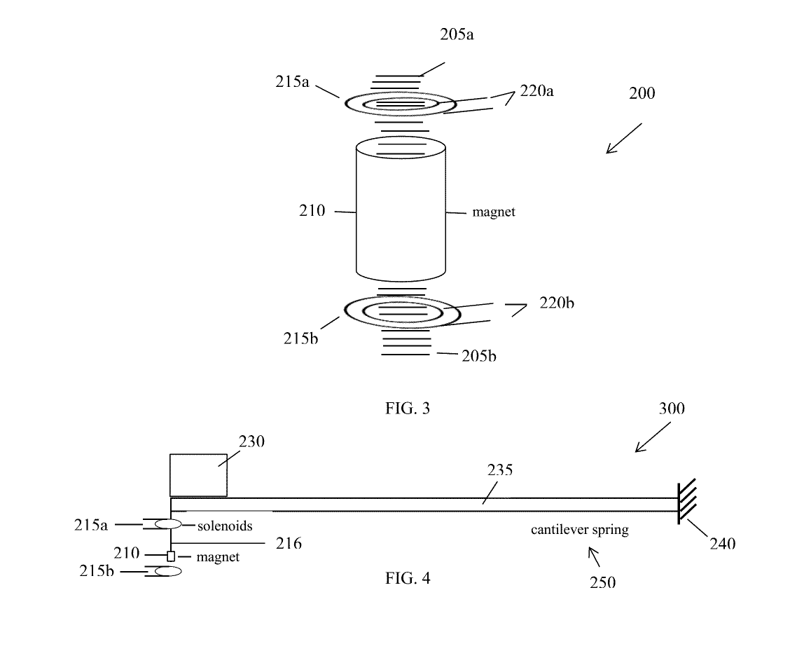

FIG. 3 is an example of a charger device 200, configured according to principles of the disclosure. Charger device 200 may be used as the charger device 145 of FIGS. 1 and 2. Charger device 200 may be coupled to the rechargeable power source 150 to replenish the charge. A recharging control circuit (not shown) may also be present to control charging of the rechargeable power source 150. Charger device 200 is configured as a linear motion charging device. The charger device 200 may comprise a pair of underdamped springs 205a, 205b located at opposite ends of a magnet 210 and a pair of solenoids 215a, 215b. The springs 205a, 205b, magnet 210 and solenoids 215a, 215b may be configured to be housed within a housing (not shown) to maintain structural integrity of these components in relation to one another and/or for attachment of the charger device during installation. Each solenoid 215a, 215b may be configured with a pair of leads 220a, 220b for connecting each solenoid to the rechargeable power source 150, which may include being connected to a recharging control circuit (not shown) to manage the recharging process. Alternately, one of the magnet and at least one solenoid may be configured to move in relation to the other to convert kinetic energy of linear motion to electromotive force.

Change in linear motion produced during movement of the door assembly 100 such as when opening and/or closing may impart forces on the charger device 200 so that the magnet 210 may oscillate linearly along a path within the solenoids 215a, 215b causing an electric current to be generated for charging the rechargeable power source 150. In this way, mechanical motion of the door assembly 100 (or a window assembly) and associated kinetic energy may be converted to an electromagnetic force for use in recharging a power source 150. Moreover, the charger device 200 may be configured to be under-damped so that the oscillation of the magnet 210 may continue after a door has come to a stop.

FIG. 4 is an example of a charger device 300, configured according to principles of the disclosure. Charger device 300 may be used as the charger device 145 of FIGS. 1 and 2. The charger device 300 works in a similar manner as the charger device 200 of FIG. 3 by converting changes in linear momentum to an electromagnetic force. The charger device 300 may include a cantilever spring 250 which may comprise a cantilever portion 235 and a spring portion 240, solenoids 215a, 215b, and a magnet 110 connected to the cantilever spring 250 such as by the connecting mechanism 216. The cantilever portion 235 may be elongated and relatively narrow.

The magnet 230 may be connected to the cantilever spring 250 proximate the second end by a connecting mechanism 216, which may be, e.g., a small rod. The spring portion 240 may be configured at a first end of the cantilever spring 250 in several different ways including, but not limited to, a finger-like section of multiple extending spring fingers, a formed piece of metal bent to create spring like pressure against a surface, and the like. The spring portion 240 and the cantilever portion 135 may comprise a metal material, a plastic material, a polymer material, combinations thereof, or the like. A weight 130 may be connected to the cantilever spring 250 at a second end opposite the first end.

When installed in a door assembly, the first end of cantilever spring 250 is configured to push against a surface of a section 105a by the spring portion 240. The surface may be an internal surface of one of the sections such as section 105a. Motion of the door assembly 100, such as when opening and/or closing the door assembly 100, may impart forces on the cantilever spring 250 causing the weight 230 to move in a vertical direction, upwards and/or downwards. The spring 250 may be configured to be under-damped so that it vibrates, perhaps several times, as a result of the changes in momentum. The magnet 110 is configured to move within the solenoids 215a, 215b as the weight 230 moves as a result of kinetic energy from movement of the door assembly 100 such as when opening and/or closing. An electric current may be generated in the solenoids which may pass through the pair of leads 220a, 220b for use in recharging a rechargeable power source 150. The solenoids 215a, 215b and magnet 110 may be housed in a housing (not shown) to keep these components aligned with one another and to assist in mounting. A recharging control circuit (not shown) may be used to manage the recharging process.

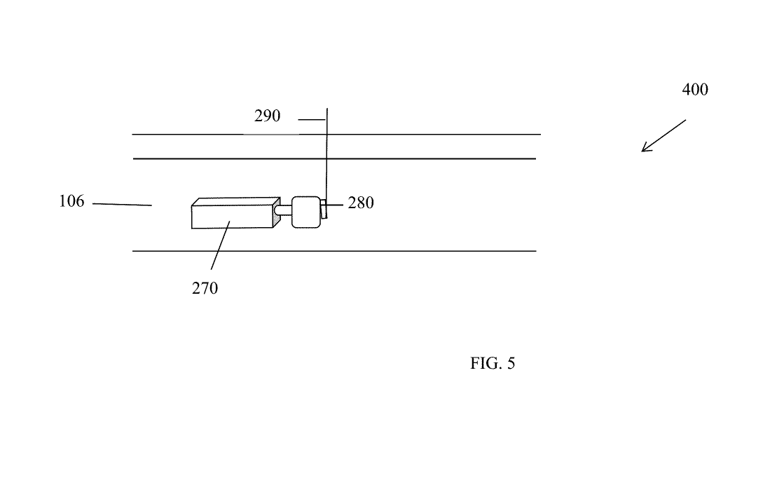

FIG. 5 is an example of a charger device 400, configured according to principles of the disclosure. The charging device 400 may include a generator 280 connected to a spring tensioned spool 280. A tensioning device 290 such as, e.g., a chord, belt or similar device may be wrapped around the spring tensioned spool 280 with one end of the tensioning device attached to or proximate a doorway frame 107 (FIG. 1). This configuration may be suitable for a rollup type of door. When the doorway assembly 100 moves such as when opening or closing, the spinning of the spring tensioned spool 280 causes the generator 270 to turn which produces electric current for charging the rechargeable power source 150. Alternatively, a spool located at the door frame 107 may create the tension on the tensioning device 290 in lieu of the spring tensioned spool 280, which may then be a pulley.

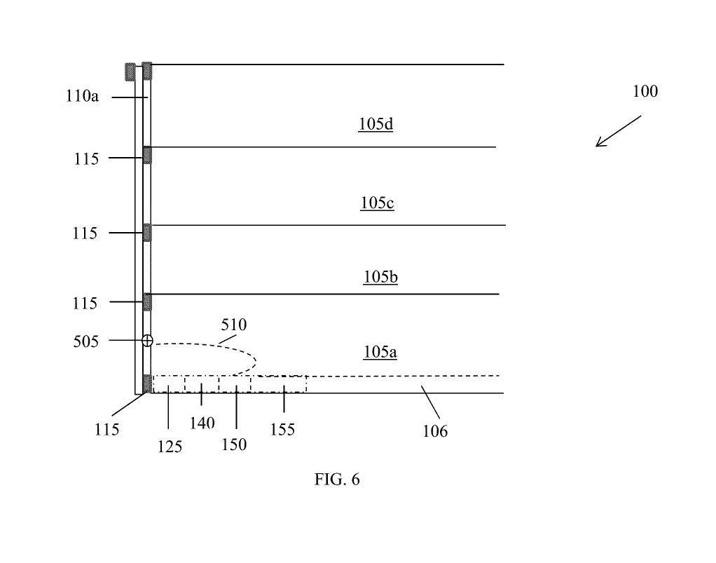

FIG. 6 is an example of a charger device 505, configured according to principles of the disclosure. In this example, one or more charging devices 505 may be configured as a generator positioned to press against a stationary support structure such as one or the tracks 110a, 110b and the generator may be mounted to one of the sections 105a-105d. When the door assembly 100 moves, such as when opening and/or closing of the door assembly 100, the charging device 505 converts kinetic energy from the door assembly motion to electromotive force by turning and creating an electric current to charge the rechargeable power source 150 via connection 510. A recharging control circuit (not shown) may be used to manage the recharging process. One or more sensors 155 may detect obstacles impeding operation of the door assembly 100. The one or more sensors 155 may comprise a vibration sensor, a reversing edge sensor, a contact sensor, or other types of sensors, commonly known in the art.

In each of the examples herein, kinetic energy may be converted to electromotive force resulting from motion of the door assembly 100 (or, alternatively, a window assembly). The kinetic energy of the linear motion of the door assembly 100 (or a single panel door) such as when opening or closing is converted to an electric current which may be used to recharge a rechargeable power source such as, e.g., a battery or a super cap. In this way, rechargeable batteries may be used for powering devices associated with door accessories such as, e.g., monitoring sensors, transmitters, alarms or the like. Because a source of recharging is now available within or on the door assembly, a longer duration of time may be expected before maintenance is required to service the electronic devices or the rechargeable batteries versus a traditional non-rechargeable battery.

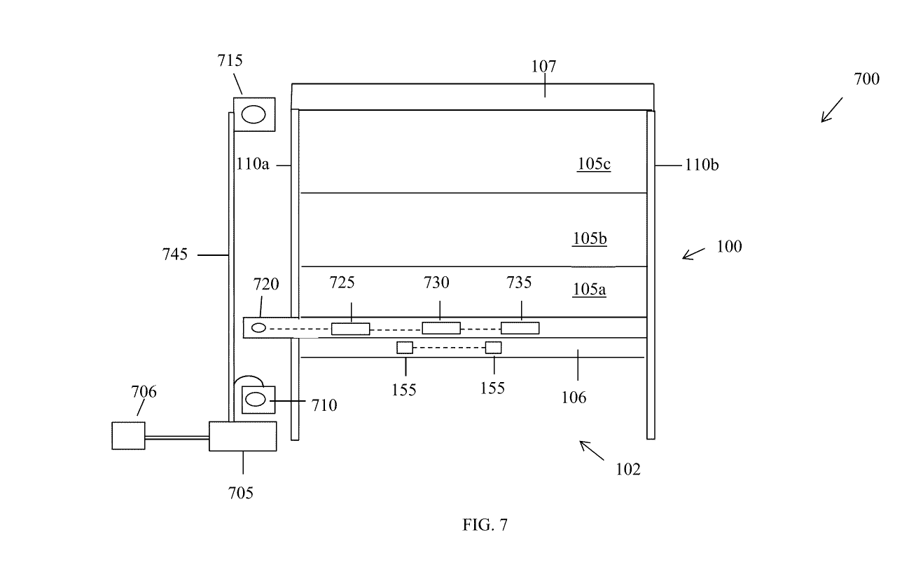

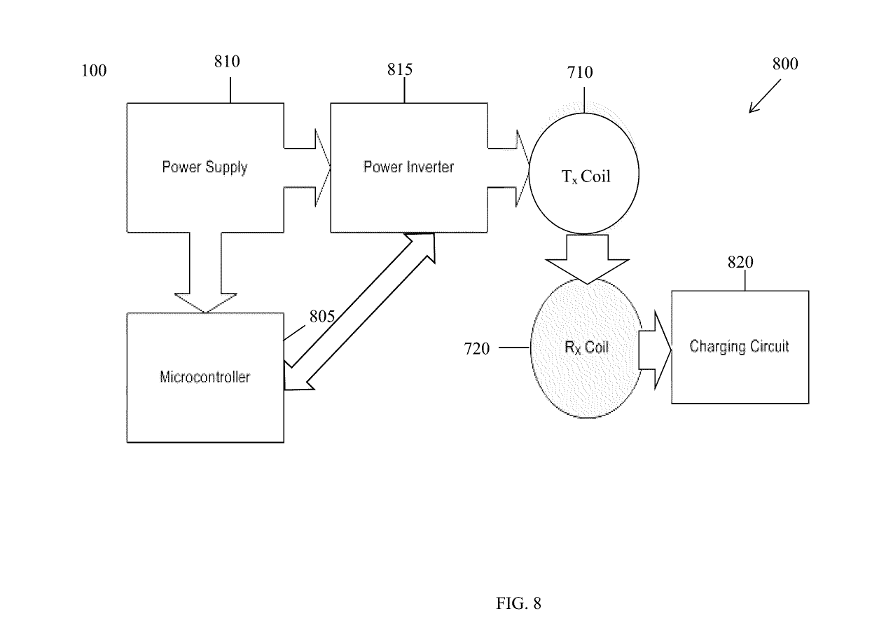

FIG. 7 is an example of a self-sustaining wireless system, configured according to principles of the disclosure. The system 700 may include one or more transmitting coils such as lower transmitting coil 710 and upper transmitting coil 715 located proximate a door or track 110a. The lower transmitting coil 710 and upper transmitting coil 715 may be connected to a transmitting circuit 705 via electrical connection 745. The transmitting circuit 705, and connected transmitting coils 710, 715, may be connected to a power supply 706, which may be, e.g., a 120v supply. A receiving coil 720 may be located on or connected to a portion of door panel 105a so that the receiving coil 720 moves as the door panels 105a-105c move when the door assembly 100 opens and closes. A receiver circuit 725 may be connected to the receiving coil 720 for receiving energy from the receiving coil 720 which in turn wirelessly receives energy induced by the transmitting coil 710 when the receiving coil 720 and transmitting coil 710 are in close proximity to one another. The receiving circuit 725 may be connected to an electrical energy storage device 730, such as, e.g., a super capacitor, to control charging and/or store energy received from the receiving coil 720. Other types of storage devices may be employed such as a battery. The receiving circuit 725 may include a charging circuit 820 (FIG. 8), but they may be separate components. The larger diameter of coils, 710, 715 and 720 may provide greater working distances. A safety sensor transmitter 735 may be connected to and powered by the electrical energy storage device 730. The safety sensor transmitter 735 may be connected to sensors 155. Sensors 155 may comprise pressure sensors that may detect obstruction of the door assembly 100, such as, e.g., encountering an unexpected object that may be passing through the opening 102 of the door assembly 100, and provide a signal to the safety sensor transmitter 735 which in turn may signal to a wireless receiver 135 that may in turn cause powered controller 130 to stop movement of the door assembly 100. The system 700 of FIG. 7 provides for recharging an electrical energy storage device 730 which may powers a detector circuit such as the safety sensor transmitter 735 and one or more sensors 155 all of which may be mounted to or on the door assembly 100 and move in conjunction with the door assembly 100. The proximity of the receiving coil 720 with the transmitting coils 710, 715 when the door is in an open state or when in a closed state provides wireless transfer of energy to components on the door assembly 100 for charging an electrical energy storage device 730. The one or more sensors 155 and safety sensor transmitter 735 in turn may be powered by the onboard electrical energy storage device 730. The safety sensor transmitter 735 may receive a first signal from the sensor 155 and may transmit a second signal which may be an alert signal to an external receiver, e.g., to receiver 135, that an obstruction may be present blocking or interfering with motion of the door assembly 100, and for eventual control by the external receiver (e.g., start or stopping) of the door assembly movement.

FIG. 8 is a block diagram of components for wireless charging, configured according to principles of the disclosure. The components of FIG. 8 may be configured in an embodiment including that of FIG. 7. A micro-controller 805 may control power supply 810 to a power inverter 815 that powers a transmit coil 710. The transmit coil 710 may convey energy such as by inductance to the receiving coil 720. The receiving coil may provide energy to a charging circuit 820 that may charge an electrical energy storage device, such as device 730, which may be a super capacitor, a battery device, or the like.

The system of FIGS. 7 and 8 may provide a technique for powering an electrical storage device on a door assembly by inductance while permitting the door assembly to be opened and closed. Alternatively, capacitive type coupling may be employed. Although the transfer of energy typically occurs when the door assembly 100 is either in a first state, i.e., an open state, or in a second state, i.e., a closed state, it is possible to have other intermediate states for charging, if an application requires more or different states.

While the invention has been described in terms of examples, those skilled in the art will recognize that the invention can be practiced with modifications in the spirit and scope of the appended claims. These examples are merely illustrative and are not meant to be an exhaustive list of all possible designs, embodiments, applications or modifications of the invention.

What is claimed:

1. A charging device for use with a door assembly, comprising:
a charging device configured to convert kinetic energy of linear motion to electromotive force; and
a rechargeable power source coupled to the charging device,
wherein the linear motion is caused by movement of the door assembly to charge the rechargeable power source.

2. The charging device of claim 1, wherein the charging device comprises a generator connected to the door assembly and the generator configured to move by frictional contact against a support member that supports the door assembly to convert kinetic energy of linear motion to electromotive force.

3. The charging device of claim 1, wherein the charging device comprises:
a magnet; and
at least one solenoid, wherein one of the magnet and at least one solenoid is configured to move in relation to the other to convert kinetic energy of linear motion to electromotive force.

4. The charging device of claim 1, wherein the charging device comprises:
a cantilever spring;
a magnet connected to the cantilever spring; and
at least one solenoid configured to permit the magnet to move therewithin to convert kinetic energy of linear motion to electromotive force.

5. The charging device of claim 4, further comprising a weight connected proximate one end of the cantilever spring to cause the magnet to move in relation to the at least one solenoid.

6. The charging device of claim 1, wherein the charging device comprises:
a generator configured to be mounted to the door assembly and configured to be connected by a tensioning device to a support structure of the door assembly,
wherein the generator is configured to be propelled by motion of the door assembly to convert kinetic energy of linear motion to electromotive force.

7. The charging device of claim 1, wherein the charging device comprises:
a generator configured to be mounted to the door assembly and configured to be in contact with a stationary support structure,
wherein the generator is configured to be propelled by motion of the door assembly by frictional contact with the stationary support structure to convert kinetic energy of linear motion to electromotive force.

8. The charging device of claim 1, wherein the charging device is mounted in or on the door assembly.

9. The charging device of claim 1, wherein the rechargeable power source comprises one of: a battery and a super cap.

10. A method of wirelessly recharging a power source, the steps comprising:
providing at least one transmitting coil proximate but not contacting a door assembly;
providing a receiving coil on the door assembly configured to receive energy wirelessly from the at least one transmitting coil by inductance; and
charging at least one electrical storage device on the door assembly.

11. The method of claim 10, further comprising mounting a safety sensor transmitter on the door assembly, the safety sensor transmitter configured to wirelessly provide an alert signal powered by the at least one electrical storage device for stopping movement of the door assembly.

12. The method of claim 10, further comprising configuring a sensor on the door assembly to detect obstructions, the sensor coupled to the safety sensor transmitter.

13. The method of claim 10, wherein the receiving coil receives energy by inductance from the at least one transmitting coil.

14. The method of claim 10, wherein the at least one transmitting coil comprises two transmitting coils configured to be operably inductively coupled to the receiving coil when the door assembly is in a first state and/or a second state.

15. A system for of wirelessly recharging a power source, comprising:
at least one transmitting coil positionable proximate a door assembly; and
a receiving coil configured on the door assembly and coupled to an electrical storage device, the electrical storage device configured on the door assembly,
wherein the at least one transmitting coil provides energy to the receiving coil when the door assembly is in at least one of: a first state and a second state.

16. The system of claim 15, further comprising a sensor configured on the door assembly to detect obstructions in the door pathway, the sensor powered by the electrical storage device.

17. The system of claim 16, further comprising a transmitter configured to receive a first signal from the sensor and configured to transmit a second signal.

18. The system of claim 15, wherein the at least one transmitting coil is coupled to the receiving coil by induction.

19. The system of claim 15, wherein the electrical storage device comprises a super capacitor.

20. The system of claim 10, wherein the first state corresponds to an open position of the door assembly and the second state comprises a closed state of the door assembly.
